(19) United States
(12) Patent Application Publication
(10) Pub. No.: US 2026/0225712 A1
(43) Pub. Date: Aug. 6, 2026

(54) INTELLIGENT PRESSURE CONTROL VALVE FOR AIRCRAFT

(71) Applicant: Hydro-Aire Aerospace Corp., Burbank, CA (US)

(72) Inventors: Nguyen Tram, Chino Hills, CA (US); David Deloria, Santa Clarita, CA (US); Ryan Sands, Los Angeles, CA (US); Ron Raby, Chatsworth, CA (US); Ahmed Yacine Louchahi, Orange, CA (US); Arin Hayrapetian, Santa Clarita, CA (US)

(21) Appl. No.: 19/408,071

(22) Filed: Dec. 3, 2025

Related U.S. Application Data
(60) Provisional application No. 63/752,598, filed on Jan. 31, 2025.

(51) Int. Cl. B64C 25/46; B60T 7/02; B60T 7/12; B60T 8/17; B60T 8/171; B60T 8/172; B60T 8/1761; B60T 8/58; B60T 13/68; B64C 25/34; B64D 45/00; B64F 5/60

(52) U.S. Cl. CPC B64C 25/46; B60T 7/02; B60T 7/12; B60T 8/1703; B60T 8/171; B60T 8/172; B60T 8/17616; B60T 8/58; B60T 13/686; B64C 25/34; B64D 45/00; B64F 5/60; B60T 2240/00; B60T 2270/402; B60T 2270/406; B60T 2270/413; B64D 2045/0085

(57) ABSTRACT

Systems and methods for replacing federated control systems for hydraulically actuated brakes with intelligent brake control valves operating according to a distributed control architecture are disclosed herein. An intelligent brake control valve includes a housing, a first shutoff valve, wherein the first shutoff valve modulates a supply of a pressurized hydraulic fluid to and from the intelligent brake control valve, a first control valve, wherein the first control valve modulates a hydraulic fluid pressure along a line connecting the intelligent brake control valve and a first hydraulically actuated brake of an aircraft, a pressure transducer, one or more input/output interfaces, a processor, and a memory, containing instructions for execution by the processor.

### CROSS-REFERENCE TO RELATED APPLICATIONS

This application claims benefit of U.S. Provisional Application No. 63/752,598, filed January 31, 2025, entitled INTELLIGENT PRESSURE CONTROL VALVE FOR AIRCRAFT (Atty. Dkt. No. CCAB01-00032), the specification of which is incorporated by reference herein in its entirety.

### TECHNICAL FIELD

This disclosure relates to distributed control of hydraulic systems in aircraft. More specifically, the present disclosure relates to an intelligent pressure control valve for aircraft hydraulic systems, most notably, hydraulic actuators for antiskid braking systems.

### BACKGROUND

As exemplified by, for example, the continued and forecasted use of the Boeing 737 and B-52 series aircraft, popular airframes can have multi-decade service lives, which can span entire eras of control system technology. Introduced into service in 1955, the B-52 presents an extreme case of this phenomenon, having flown during eras in which the state of the art for aircraft control systems variously relied upon vacuum tubes, solid state electronics and modern, multi-core processor chips.

Modernizing aircraft and updating constituent systems of airplanes presents a unique and significant array of forward- and backward- compatibility challenges which must be overcome while at the same time, not introducing size, weight, and power (“SWaP”) penalties, or exceeding the form factor provided by the airframe.

The macro-level design trends within the field of sensor/control systems for major airframe systems, such as engines, hydraulic systems, and onboard power supplies has been a move away from federated control, wherein each major system operated under the control of its own central controller, which received its own sensor data, and distributed control inputs to hydraulic actuators, contactors, servo motors, and other non-autonomous components (i.e., operating solely under the control of the central controller for the system) towards distributed control, wherein previously non-autonomous components now include a significant measure of built-in control intelligence.

Given the enormous number of constituent systems of an aircraft and the interrelatedness of these systems, migrating control intelligence away from the central controllers of the previous generation of federated control systems, while at the same time, avoiding SWaP penalties remains a source of technical challenges and opportunities for improvement in the art.

### SUMMARY

This disclosure relates to distributed control of hydraulic systems in aircraft. More specifically, the present disclosure relates to an intelligent pressure control valve for aircraft hydraulic systems, most notably, hydraulic actuators for antiskid braking systems.

In a first embodiment, an intelligent brake control valve includes a housing, a first shutoff valve, wherein the first shutoff valve modulates a supply of a pressurized hydraulic fluid to and from the intelligent brake control valve, and a first control valve, wherein the first control valve modulates a hydraulic fluid pressure along a line connecting the intelligent brake control valve and a first hydraulically actuated brake of an aircraft. The intelligent brake control valve can further include a pressure transducer, one or more input/output interfaces, a processor, and a memory. The memory can include instructions which, when executed by the processor, cause the intelligent brake control valve to obtain, from a distributed network computer of the aircraft, a braking input, determine, by the processor based on the braking input, a first braking command specifying a first position of the first control valve, responsive to the first braking command, cause the first shutoff valve to open, responsive to the first braking command, cause the first control valve to move to the first position, obtain, via the one or more input/output interfaces, a current pressure value from the pressure transducer in the line connecting the intelligent brake control valve and the first hydraulically actuated brake, obtain, from a wheelspeed sensor, a current wheelspeed of a wheel connected to the first hydraulically actuated brake, and determine, by the processor, a second braking command, wherein the second braking command is determined based on the current wheelspeed of the wheel and the current pressure value from the pressure transducer.

In a second embodiment, a method of brake control includes obtaining at an intelligent brake control valve, from a distributed network computer of an aircraft, a braking input. The intelligent brake control valve can include a housing, a first shutoff valve, wherein the first shutoff valve modulates a supply of a pressurized hydraulic fluid to and from the intelligent brake control valve, a first control valve, wherein the first control valve modulates a hydraulic fluid pressure along a line connecting the intelligent brake control valve and a first hydraulically actuated brake of the aircraft, a pressure transducer, and one or more input/output interfaces. The method also includes determining, based on the braking input, a first braking command, wherein the first braking command specifies a first position of the first control valve, responsive to the first braking command, causing the first shutoff valve to open, responsive to the first braking command, causing the first control valve to move to the first position, obtaining, via the one or more input/output interfaces, a current pressure value from the pressure transducer in the line connecting the intelligent brake control valve and the first hydraulically actuated brake, obtaining, from a wheelspeed sensor, a current wheelspeed of a wheel connected to the first hydraulically actuated brake, and determining, a second braking command, wherein the second braking command is determined based on the current wheelspeed of the wheel and the current pressure value from the pressure transducer.

In a third embodiment, a non-transitory machine-readable medium includes instructions which, when executed by a processor, cause an intelligent brake control valve comprising a housing; a first shutoff valve, wherein the first shutoff valve modulates a supply of a pressurized hydraulic fluid to and from the intelligent brake control valve; a first control valve, wherein the first control valve modulates a hydraulic fluid pressure along a line connecting the intelligent brake control valve and a first hydraulically actuated brake of an aircraft; a pressure transducer; and one or more input/output interfaces, to obtain, from a distributed network computer of the aircraft, a braking input. When executed, the instructions further cause the intelligent brake control valve to determine, based on the braking input a first braking command, wherein the first braking command specifies a first position of the first control valve, responsive to the first braking command, cause the first shutoff valve to open, responsive to the first braking command, cause the first control valve to move to the first position, obtain, via the one or more input/output interfaces, a current pressure value from the pressure transducer in the line connecting the intelligent brake control valve and the first hydraulically actuated brake, obtain, from a wheelspeed sensor, a current wheelspeed of a wheel connected to the first hydraulically actuated brake, and determine, a second braking command, wherein the second braking command is determined based on the current wheelspeed of the wheel and the current pressure value from the pressure transducer.

Any of the following features may be combined with the embodiments described above. The memory of the intelligent brake control valve can include instructions which, when executed by the processor, further cause the brake control valve to provide brake system health status information to the distributed network computer, wherein the brake system health status information comprises at least one of the current pressure value from the pressure transducer, the current wheelspeed from the wheel, or an output from a hardware safety monitor. The memory can include instructions, which when executed by the processor, cause the intelligent brake control valve to obtain, via the one or more input/output interfaces, from a second intelligent brake control valve, a second current pressure from a second pressure transducer in a second line connecting the second intelligent brake control valve and a second hydraulically actuated brake, obtain, via the one or more input/output interfaces, from the second intelligent brake control valve, a second current wheelspeed of a second wheel connected to the second hydraulically actuated brake and determine, by the processor, the second braking command based at least in part on the second current pressure and the second current wheelspeed. The memory can include instructions which, when executed by the processor, cause the intelligent brake control valve to send, via the one or more input/output interfaces, the current pressure value and the current wheelspeed to one or more input/output interfaces of a second intelligent brake control valve. The memory can include instructions which, when executed by the processor, cause the intelligent brake control valve to determine, based on the current wheelspeed of the wheel and the current pressure value from the pressure transducer, whether the wheel is in, or is approaching a lock-up condition, wherein, the second braking command is determined based at least in part on whether the wheel is in, or is approaching the lock-up condition, and wherein the second braking command causes the first control valve to reduce the pressure in the line connecting the intelligent brake control valve to the first hydraulically actuated brake. The braking input can be at least one of: received by the distributed network computer from a user control of the aircraft or generated internally by the distributed network computer.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example airframe in which apparatuses and methods according to the present disclosure can be practiced;

FIG. 2A illustrates an example of a brake system according to a federated control architecture;

FIG. 2B illustrates an example of a brake system employing a distributed control architecture according to various embodiments of this disclosure;

FIG. 3A illustrates an example of a single-channel intelligent brake control valve according to various embodiments of this disclosure;

FIG. 3B illustrates an example of a two-channel intelligent brake control valve according to various embodiments of this disclosure; and

FIG. 4 illustrates operations of an example method for implementing distributed control of an aircraft braking system according to embodiments of this disclosure.

### DETAILED DESCRIPTION

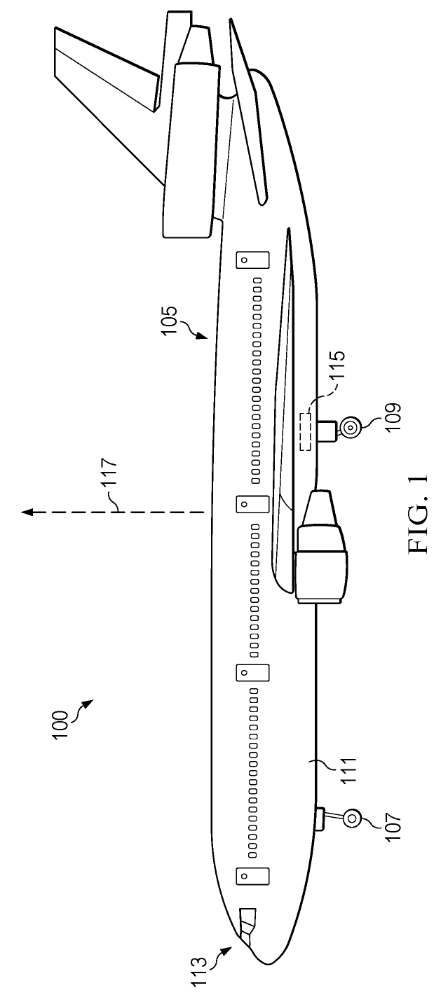

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

The macro-level design trends within the field of sensor/control systems for major airframe systems, such as engines, hydraulic systems, and onboard power supplies has been a move away from federated control, wherein each major system operated under the control of its own central controller, which received its own sensor data, and distributed control inputs to hydraulic actuators, contactors, servo motors, and other typically non-autonomous components (i.e., operating solely under the control of the federated central controller for the system) towards distributed control, wherein those previously non-autonomous components now include some measure of built-in control and monitoring intelligence. Given the enormous number of constituent systems of aircraft and the interrelatedness of these systems, migrating control intelligence away from the federated central controllers of the previous generation of federated control systems, while at the same time, avoiding SWaP penalties remains a source of technical challenges and opportunities for improvement in the art.

FIG. 1 illustrates example technical problems addressed by embodiments according to this disclosure. Referring to the example of FIG. 1, an aircraft 100 comprising an airframe 105 and a landing gear system 107/109, set out in a “tricycle” layout, is shown in the figure. While a “tricycle” layout is shown in FIG. 1, the landing gear system 107/109 may alternatively be set out in a “conventional” layout. The landing gear system 107/109 comprises a nosewheel 107 and a pair of main wheels 109 straddling the centerline of fuselage 111. Aircraft 100 has a brake system comprising, at a minimum, a set of brakes on each of main wheels 109 and a user control 113 (typically, a sensor connected to one or more pedals in the cockpit). The set of brakes on each of the main wheels 109 can be disc brakes comprising one or more fixed stators and one or more metal, metallic, or ceramic rotors connected to the same axle(s) as main wheels 109. The one or more fixed stators can include one or more sets of hydraulically actuated brake pistons which bring one or more fixed stators into clamping contact with the rotors, thereby slowing the rotation of the wheel. Actuation of the hydraulically actuated brake pistons is performed by selectively opening and closing one or more hydraulic brake control valves 115, to increase or decrease a level of hydraulic pressure forcing the rotors against the stators.

Regardless of the landing gear configuration, generally, lock-up of aircraft brakes and skidding wheels during ground operations are almost universally undesirable, as aircraft are not rally cars and are generally incapable of controlled operation while sliding, particularly when the nose of the aircraft experiences torsional forces around its yaw axis (e.g., yaw axis 117 of aircraft 100 in FIG. 1) or is no longer substantially aligned with the aircraft’s direction of travel. Accordingly, to keep aircraft within the control envelope (i.e., the range in which the aircraft can be safely and effectively controlled) during braking, aircraft can be provisioned with antiskid systems, which, at a minimum, monitor sensor data showing the wheelspeed of a wheel to test for lock-up conditions or evidence of skidding. In some embodiments, the antiskid system may also consider sensor data showing the forward moving speed of the aircraft, wheelspeed of other wheels, or the braking state of other wheels. In response to sensor data showing a wheel at, or approaching a lock-up or skid condition, the antiskid system issues a control signal to the brake valve (e.g., the one or more hydraulic brake control valves 115), which modulates the hydraulic pressure to the hydraulically actuated brake piston, to reduce the braking pressure applied to the wheel to get it rolling again.

While FIG. 1 has been described with reference to an aircraft with disc brakes and a “tricycle” landing gear configuration, the present disclosure should not be construed as being limited to any particular landing gear configuration or brake type. Embodiments according to the present disclosure are applicable in any main landing gear configuration (e.g., conventional, simple gear, two-wheel gear, trailing link gear, gear truck, or other landing gear configurations) which utilizes hydraulically actuated disc or drum brakes.

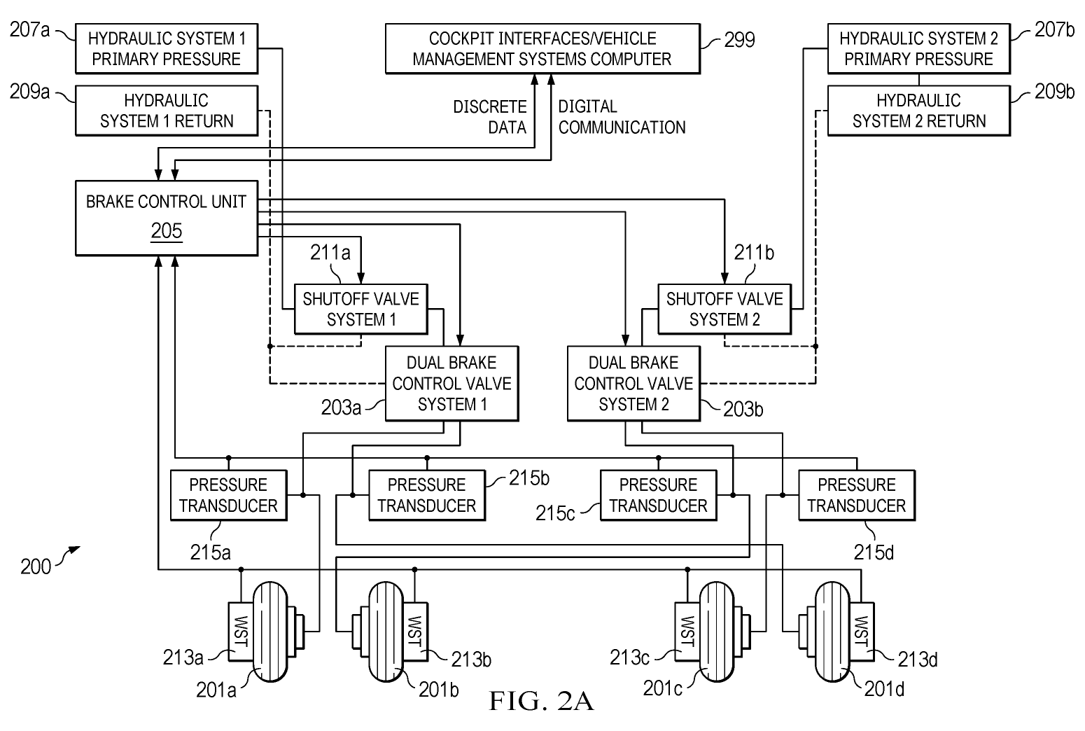

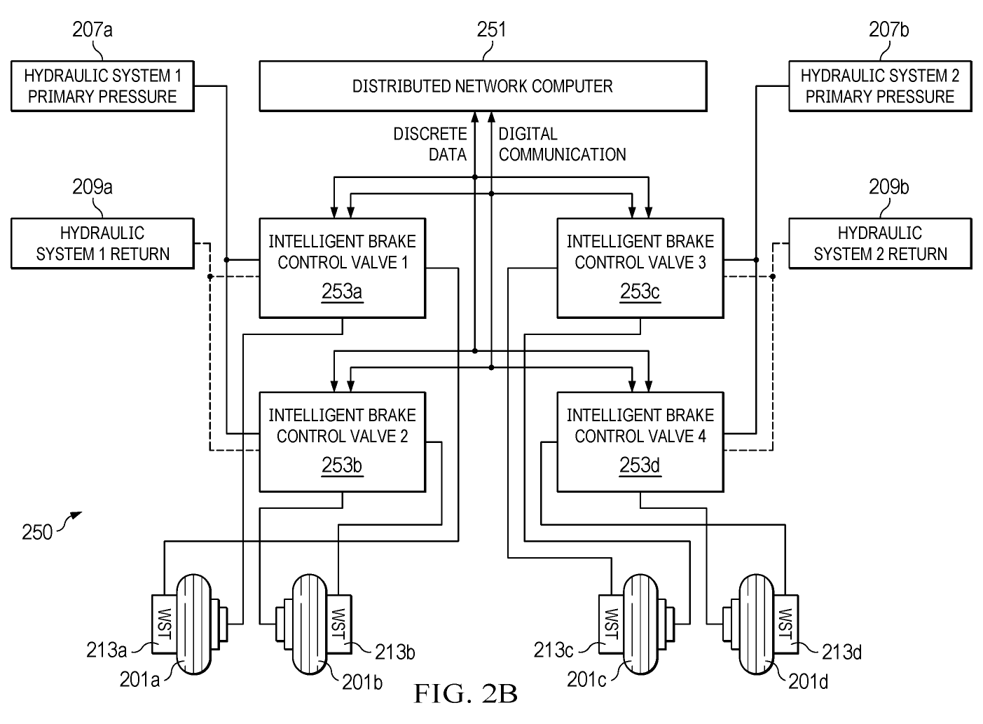

FIG. 2A illustrates an example of a brake system 200 in an aircraft embodying a federated control architecture, to highlight technical improvements provided by embodiments according to this disclosure. Referring to the illustrative example of FIG. 2A, brake system 200 comprises a plurality of hydraulically actuated brakes 201a-201d. Each of brakes 201a-201d applies a braking force modulated by one of first brake control valve system 203a and second brake control valve system 203b, wherein each of brake control valve systems 203a and 203b are electrically actuated valves operating according to electrical controls provided by brake control unit 205. The electrically actuated valves of first brake control valve system 203a modulate the pressure of hydraulic fluid (typically, between brakes 201a and 201d) from first primary pressure supply 207a, through brakes 201a and 201d, and back to first hydraulic system return 209a. Similarly, the electrically actuated valves of second brake control valve system 203b modulate the flow of hydraulic fluid from second primary pressure supply 207b, through brakes 201b and 201c, and back to second hydraulic return 209b. As shown in FIG. 2A, brake system 200 further comprises a first shutoff valve system 211a and a second shutoff valve system 211b. Because each of first and second brake control valve systems 203a and 203b and the individual actuators of brakes 201a-201d are part of non-autonomous systems with no feedback or control mechanisms of their own, brake system 200 interposes first and second shutoff valve systems 211a and 211b, which are electrically actuated and operate under the control of brake control unit 205.

As noted elsewhere, antiskid systems for aircraft (and other vehicles) are, at a minimum, premised on the availability of sensor data as to the current rotational state of a wheel while brakes 201a-201d are applied, and potentially other sensor data affecting the slip between the wheels of the landing gear and the surface upon which it rolls. Accordingly, in this example, brake system 200 comprises a plurality of wheelspeed transducers 213a-213d, wherein each wheel is connected to one of wheelspeed transducers 213a-213d. As further shown in FIG. 2A, each of wheelspeed transducers 213a-213d connects to brake control unit 205. In this example, brake system 200 further comprises pressure transducers 215a-215d, wherein each pressure transducer is positioned between a brake control valve system (e.g., brake control valve system 203a) and a brake (e.g., brake 201a). Each of pressure transducers 215a-215d generates a signal based on the amount of pressure in a line feeding to one or more hydraulically actuated brake pistons of one of brakes 201a-201d. The signal generated by each of pressure transducers 215a-215d is a proxy for the amount of braking force being applied at the downstream brake, and this signal is routed back to brake control unit 205. As further shown in FIG. 2A, brake control unit 205 can be, in turn, controlled through a cockpit interfaces/vehicle management systems computer 299.

In the example of FIG. 2A, brake control unit 205 is configured to be the central point of system intelligence for receiving sensor data from each of wheelspeed transducers 213a-213d and pressure transducers 215a-215d, control inputs from the aircraft’s flight computer (e.g., cockpit interfaces/vehicle management systems computer 299) and other sensors into control signals to first and second brake control valve systems 203a-203b and first and second shutoff valve systems 211a-211b.

As skilled artisans will appreciate, concentrating all of the capacity for receiving sensor feedback, determining appropriate braking inputs, and relaying the braking inputs through brake control valve systems 203a-203b and shutoff valve systems 211a-211b solely at brake control unit 205 can impose significant SWaP penalties associated with potentially lengthy cable runs between each sensor and brake control unit 205 and separate middle-layer hardware for translating electrical control signals from brake control unit 205 into activity of mechanical systems. Further, brake system 200 can present robustness problems, in that the antiskid functionality of all of the aircraft’s brakes is dependent on the operation of brake control unit 205.

FIG. 2B of this disclosure illustrates a second or alternative brake system 250 embodying a distributed architecture and utilizing intelligent pressure control valves 253a-253d according to embodiments of this disclosure. For consistency and convenience of cross-reference, elements common to both FIGS. 2A and 2B are numbered similarly.

Referring to the illustrative example of FIG. 2B, brake system 250 relieves the SWaP costs associated with consolidating all of the control logic for modulating brake control valves in response to sensor data in a single controller (e.g., brake control unit 205), and provides greater processing robustness by distributing the control logic for implementing antiskid braking across a plurality of controllers. Thus, in embodiments according to FIG. 2B, loss of a single controller does not necessarily translate to an overall loss of an antiskid functionality (as could happen if brake control unit 205 in FIG. 2A were rendered inoperative).

As shown in the example of FIG. 2B, with reference to FIG. 2A, brake control unit 205 can be replaced by distributed network computer 251. Further, brake control valve

systems 203a-203b, shutoff valve systems 211a-211b, and pressure transducers 215a-215d are eliminated. Brake system 250 employs a simplified architecture, wherein at least some of the control logic for receiving feedback from wheelspeed or hydraulic pressure sensors and modulating the flow of pressurized hydraulic fluid to a hydraulically actuated brake piston is migrated to one or more of intelligent brake control valves 253a-253d. Each of intelligent brake control valves 253a-253d modulates the flow of hydraulic fluid along a hydraulic circuit between a primary pressure supply (e.g., first primary pressure supply 207a), the intelligent brake control valve (e.g., intelligent brake control valve 253a), a brake (e.g., brake 201a), and a hydraulic fluid return (e.g., first hydraulic system return 209a). Each of intelligent brake control valves 253a-253d is configured to receive sensor feedback from, at a minimum, a wheelspeed sensor (e.g., wheelspeed transducer 213a) for its wheel, while brakes 201a-201d are applied. Additionally, each of intelligent brake control valves 253a-253d is configured to receive control inputs from distributed network computer 251. Depending on the embodiment, distributed network computer 251 can comprise, without limitation, cockpit interfaces/vehicle management systems computer 299 in FIG. 2A. Additionally, each of intelligent brake control valves 253a-253d can be proportioned to occupy the same or smaller form factor as at least one of shutoff valve systems 211a-211b or brake control valve systems 203a-203b for easy retrofitting. According to some embodiments, in addition to being connected to distributed network computer 251 and at least one channel for receiving wheelspeed sensor data from a wheelspeed sensor (e.g., wheelspeed transducer 213a), each of intelligent brake control valves 253a-253d can be networked, either directly, or indirectly to each other, to facilitate redundancy, braking coordination, and the exchange of sensor and braking input data.

In some embodiments, a braking input is generated by, or received at, distributed network computer 251. In some examples, the braking input may be an operator-generated one (i.e., a pilot pressing a brake pedal, causing a braking input to be received at distributed network computer 251). In some examples, the braking input can be programmatically generated (e.g., in response to a combination of factors indicating that the aircraft is parked, such as a speed of zero and a powering down of all of the engine(s)).

In response to the braking input being received or generated at distributed network computer 251, digital signals (e.g., signals utilizing control area network bus (CANBUS)) protocols are sent from distributed network computer 251 to each of intelligent brake control valves 253a-253d. Each of intelligent brake control valves 253a-253d modulates a valve, which in turn modulates the flow of hydraulic pressure to the hydraulically actuated brake piston. The modulation is based at least in part on control logic that determines a brake force based on wheelspeed sensor data received at and implemented by a controller of the corresponding intelligent brake control valve. For example, in response to wheelspeed sensor data from wheelspeed transducer 213a indicating that the brake 201a is, or is about to skid, the determination of the skid condition and adjustment of the pressure provided to brake 201a can be performed at intelligent brake control valve 253a.

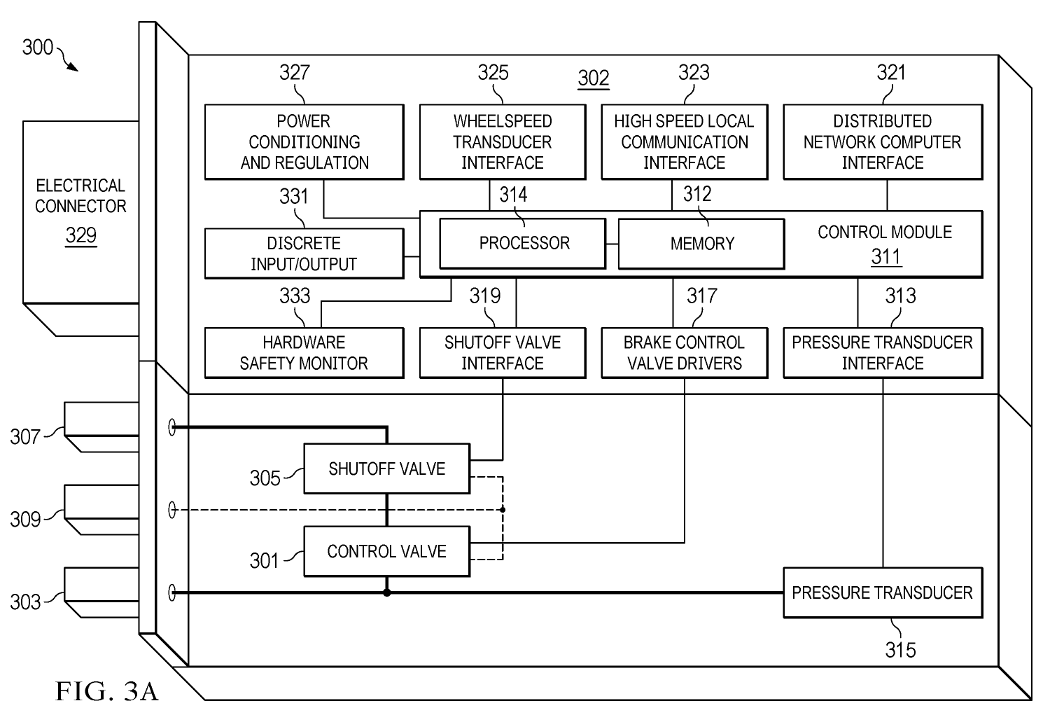

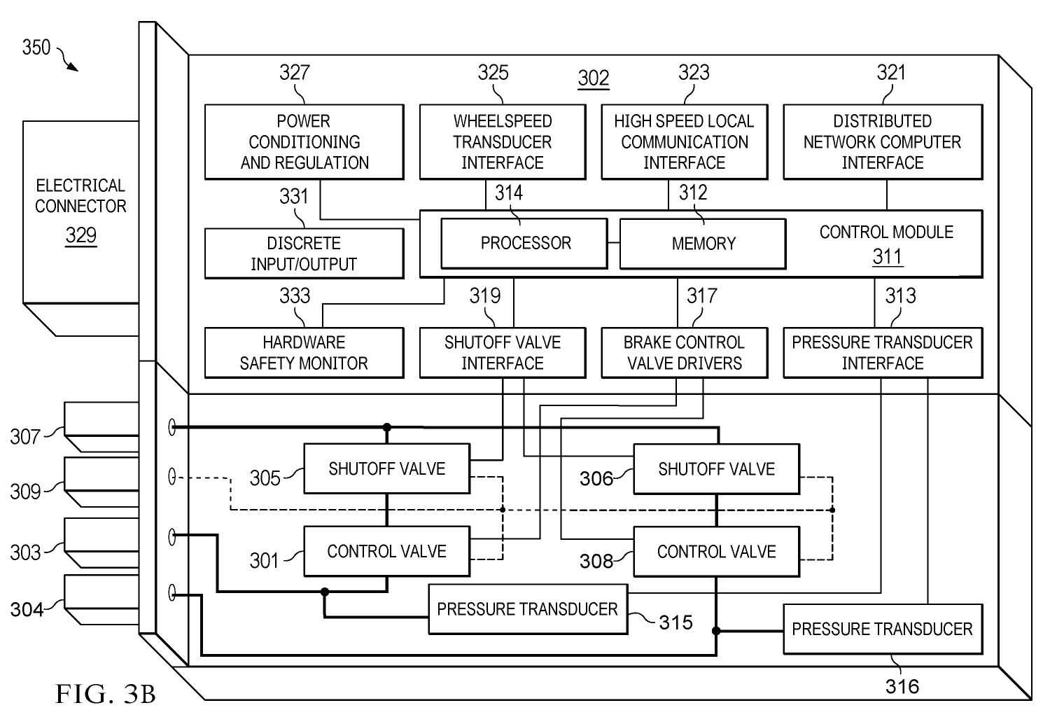

FIG. 3A illustrates the architecture of an example single-channel intelligent brake control valve 300 (e.g., intelligent brake control valve 253a in FIG. 2B) according to embodiments of this disclosure. As noted elsewhere in this disclosure, intelligent brake control valve 300 can include a housing 302 of sufficiently equivalent size and shape to one or both of a pre-existing brake control valve system (e.g., brake control valve system 203a in FIG. 2A) or shutoff valve system (e.g., shutoff valve system 211a in FIG. 2A) as to facilitate easy retrofitting. Intelligent brake control valve 300 comprises one or more control valves 301, which can be electrically actuated valves (e.g., servo valves) for modulating a flow of pressurized hydraulic fluid to a hydraulically actuated brake piston via a brake port 303. Intelligent brake control valve 300 further comprises one or more shutoff valves 305, which can interrupt the branch of the fluid circuit passing between a pressure supply port 307 and a return pressure port 309, through intelligent brake control valve 300. According to some embodiments, shutoff valve 305 is an electrically actuated (e.g., using a solenoid) valve, which replaces one or more shutoff valve systems (e.g., shutoff valve systems 211a-211b in FIG. 2A) of a legacy brake control system with a federated control architecture. As shown in FIG. 3A, the pressurized hydraulic fluid is provided to control valve 301 via shutoff valve 305, meaning that, if desired or necessary, shutoff valve 305 can cut off the supply of pressurized hydraulic fluid to control valve 301, thereby disabling the brake (e.g., brake 201a in FIG. 2B) connected to intelligent brake control valve 300 via brake port 303. According to certain embodiments, shutoff valve 305 is also connected to a pressure supply port 307, which is connected, either directly or indirectly, to one or more primary pressure supplies (e.g., first primary pressure supply 207a in FIG. 2B). Shutoff valve 305 can also include one or more return pressure ports 309, which is connected, either directly or indirectly, to one or more hydraulic fluid returns (e.g., first hydraulic system return 209a in FIG. 2B).

Intelligent brake control valve 300 further comprises one or more processors 314 connected to a non-transitory memory 312. The one or more processors 314 may comprise, without limitation, a microprocessor, a microcontroller, a digital signal processor, a microcomputer, a central processing unit, a field programable gate array, a programable logic device, a state machine, logic, analog, digital circuits, or the like, and any combination thereof. Further, the non-transitory memory 312 may comprise, without limitation, hard drives, solid-state drives, flash memory, optical discs, read-only memory, random access memory, static random access memory, or the like, and any combinations thereof. In some embodiments, one or more processors 314 and non-transitory memory 312 may be included in a control module 311. Control module 311, utilizing one or more processors 314 and non-transitory memory 312, may be configured with instructions embodying the control logic for responding to braking inputs from distributed network computer 251, and thereby may be capable of implementing antiskid braking, and managing the reception and, where applicable, forwarding of sensor inputs. The control module 311, one or more processors 314, and non-transitory memory 312, can, in some embodiments, be implemented as separate components, and in some embodiments, be implemented as a single component (e.g., as an application-specific integrated circuit (“ASIC”) or a system on a chip (“SOC”)).

As further illustrated in FIG. 3A, intelligent brake control valve 300 may comprise one or more pressure transducer interfaces 313 connected to a pressure transducer 315. Pressure transducer 315 can be a sensor (e.g., a piezoelectric sensor) which outputs a signal, the strength of which is proportional to the hydraulic pressure in the hydraulic line between control valve 301 and the hydraulically actuated brake piston operating under the control of intelligent brake control valve 300. The hydraulic pressure in the line between control valve 301 is a generally reliable proxy for the braking force actually being applied at the brake disc. Intelligent brake control valve 300 further comprises one or more brake control valve drivers 317, which can be configured to translate and amplify brake control signals generated by processor, memory, and control module 311 into electrical control signals for control valve 301. Intelligent brake control valve 300 also comprises one or more shutoff valve interfaces 319, which are configured to translate and amplify open/close signals from control module 311 into control signals of sufficient potential and current to cause shutoff valve 305 to open and close as instructed.

Intelligent brake control valve 300 includes a first interface 321, wherein the first interface connects intelligent brake control valve 300 to distributed network computer 251, or other upper-level computers of the aircraft. For example, first interface 321 can connect intelligent brake control valve 300 to one or more of the Engine Indicating and Crew Alerting System (“EICAS”), which displays information about the current status of the aircraft’s components in the cockpit or the central maintenance computer (“CMC”) of the aircraft, which is typically used during ground maintenance of the aircraft, rather than in flight. Intelligent brake control valve 300 includes a second interface 323, which can be a high-speed local communication interface, for communicating wheelspeed and pressure transducer sensor data between multiple intelligent brake control valves 300. As noted herein, the control logic implemented by control module 311 can, in some embodiments, operate control valve 301 and shutoff valve 305 based on what is happening at other wheels of the aircraft. In some embodiments, including, for example, aircraft with “tricycle” landing gear configurations, coordination between intelligent brake control valves (e.g., intelligent brake control valves 253a-253d in FIG. 2B) can add significant performance gains, as having unequal braking by brakes on either side of the centerline of the aircraft, even if not causing lock-up or skidding, can cause unwanted yaw motion of the aircraft. Intelligent brake control valve 300 further includes one or more wheelspeed transducer interfaces 325, which take the output signal (typically analog) from a wheelspeed transducer associated with the wheel (e.g., wheelspeed transducer 213a in FIG. 2B) and, at a minimum, digitize the output signal from the transducer to be used as an input by control module 311. Intelligent brake control valve 300 can further include one or more power conditioning and regulation modules 327, which take electricity from one or more internal power buses of the aircraft received via one or more electrical connectors 329, step the received electricity down, and where appropriate, filter the received electricity to a format (e.g., 5V DC) suitable for use by the components of intelligent brake control valve 300. Referring to the illustrative example of FIG. 3A, intelligent brake control valve 300 can further include one or more discrete input/output interfaces 331, which may be capable of connecting the control module 311 to other components/interfaces in the brake system 250 such as, without limitation, distributed network computer 251. In some embodiments, one or more discrete input/output interfaces 331 may be configured to receive inputs from physical switches and relay status signals to fault indicators. In some embodiments, one or more discrete input/output interfaces 331 may facilitate communication through digital data busses. Such communication between the various components in brake system 250 via one or more discrete input/output interfaces 331 provides for various functions or processes to be carried out. Further, in some embodiments, intelligent brake control valve 300 includes one or more hardware safety monitors 333, which can be connected to additional sensors (not shown) or further process the inputs provided by sensors already connected to intelligent brake control valve 300, such as pressure transducer 315 or wheelspeed transducers (e.g. wheelspeed transducers 213a-213d in FIG. 2B). One or more hardware safety monitors 333 can provide a further layer of assurance that the brake(s) under the control of intelligent brake control valve 300 are not malfunctioning, such as by performing an independent monitoring function for un-commanded braking. Additionally, or alternatively, one or more hardware safety monitors 333 can intermittently poll the one or more sensors within intelligent brake control valve 300 (e.g., pressure transducer 315) or connected to intelligent brake control valve 300 (e.g., wheelspeed transducers 213a-213d in FIG. 2B) to obtain health status information, which can be reported to one or more control systems of the aircraft (e.g., the EICAS, or distributed network computer 251 in FIG. 2B). The health status information may include, without limitation, a current pressure value from the pressure transducer (e.g., pressure transducer 315), the current wheelspeed of the wheel from the wheelspeed transducer (e.g., wheelspeed transducer 213a), or any other output from hardware safety monitors 333.

While the example of an intelligent brake valve controller 300 has been described with reference to a single channel embodiment (i.e., only one control valve/shutoff valve pair), other embodiments, with two or more channels operating under a distributed controller (e.g., control module 311) are possible and within the contemplated scope of this disclosure, as is illustrated in FIG. 3B.

FIG. 3B illustrates the architecture of an example two-channel intelligent brake control valve 350 (e.g., intelligent brake control valve 253a in FIG. 2B) according to embodiments of this disclosure. For consistency and convenience of cross-reference, elements common to both FIGS. 2A and 2B are numbered similarly.

Referring to the illustrative example of FIG. 3B, in addition to the components described in detail above, intelligent brake control valve 350 may comprise a second shutoff valve 306, a second control valve 308, second pressure transducer 316, and a second brake port 304. The functions of these components are similar to shutoff valve 305, control valve 301, second pressure transducer 315, and brake port 303, respectively, as set forth above. By incorporating a second channel of these components, intelligent brake control valve 350 may provide greater redundancy, increased safety, and improved control and modulation in brake system 200.

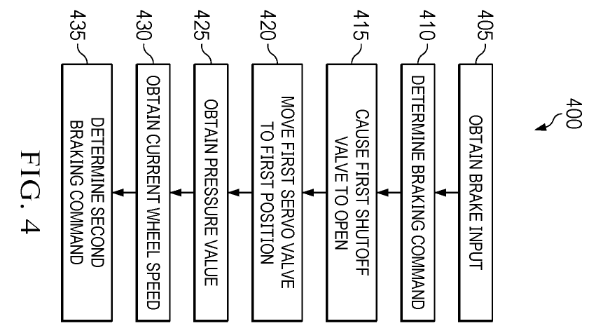

FIG. 4 illustrates operations of a method 400 of implementing distributed braking control via an intelligent brake control valve (e.g., intelligent brake control valve 300 in FIG. 3A) according to embodiments of this disclosure.

Referring to the illustrative example of FIG. 4, at operation 405, the intelligent brake control valve 300 receives from a distributed network computer (e.g., distributed network computer 251 in FIG. 2B) a brake input. According to various embodiments, the brake input is presented as a signal which can be analogous to an aircraft’s brake pedal position, in that it specifies a scalar quantity of brake application (e.g., 0% brakes, 50% brakes or 100% brakes). Notably, the received brake input does not have to specify the extent to which intelligent brake control valve 300 is open or closed. Further, the brake input can be generated in response to an operator input (i.e., a pilot actuating a brake pedal) or programmatically generated at the distributed network computer (e.g., a set of conditions, such as zero ground speed, and engines powered down) associated with automatic application of the brakes.

At operation 410, the intelligent braking control valve 300 determines a braking command for implementing the received brake input. As used in this disclosure, the expression “braking command” encompasses one or more hardware-level inputs (e.g., opening a valve to a specified position) for actuating a brake according to the received brake input. The braking command can translate the brake input received at operation 405 to a specific position or change of position of one or more valves of the intelligent braking control valve 300.

At operation 415, the intelligent brake control valve 300, in response to the generated braking command, causes a first shutoff valve (e.g. shutoff valve 305 in FIG. 3A) to be open. Depending on the current state of the first shutoff valve, operation 415 may comprise merely confirming that the first shutoff valve is already open, or affirmatively moving the valve from a closed position to an open position. By opening the first shutoff valve (e.g., shutoff valve 305 in FIG. 3A), a control valve (e.g., control valve 301) which modulates hydraulic pressure to the hydraulically actuated brake piston is “armed” and can modulate a braking force applied to the wheel through the brake discs.

At operation 420, the intelligent brake control valve 300 moves the control valve to a first position, thereby beginning to implement the brake operation commanded by the brake input.

At operation 425, the intelligent brake control valve 300 obtains a pressure value from a pressure transducer (e.g., pressure transducer 315) in the brake line connecting the control valve to the hydraulic actuator of the controlled brake. As noted elsewhere in this disclosure, the pressure in the brake line is, during normal operation (e.g., when the brake line is neither severed nor broken) an effective proxy for the amount of stopping force being applied through the controlled brake.

At operation 430, the intelligent brake control valve obtains a current wheelspeed of the wheel while brakes 201a-201d are applied (e.g., from wheelspeed transducer 213a in FIG. 2B).

At operation 435, the intelligent brake control valve determines based on the current wheelspeed of the wheel while brakes 201a-201d are applied and the current pressure value in the brake line, a second braking command. The second braking command can be a refinement of the initial braking command based on the sensor feedback received after implementing the first braking command. For example, if the wheelspeed is not decreasing, the control valve can be opened to increase the pressure at the hydraulically actuated brake piston. Alternatively, if the wheelspeed has dropped, or is dropping to an extent suggesting wheel lock-up or imminent wheel lock-up, the braking force can be reduced. Operations 410 through 435 can be looped during a duration specified by the brake input, such that an optimized braking force is determined and implemented at the intelligent braking controller.

In one example embodiment an intelligent brake control valve comprises a housing, a first shutoff valve, wherein the first shutoff valve modulates a supply of a pressurized hydraulic fluid to and from the intelligent brake control valve, a first control valve, wherein the first control valve modulates a hydraulic fluid pressure along a line connecting the intelligent brake control valve and a first hydraulically actuated brake of an aircraft, a pressure transducer, one or more input/output interfaces, a processor, and a memory. The memory contains instructions which, when executed by the processor, cause the intelligent brake control valve to obtain, from a distributed network computer of the aircraft, a braking input, determine, by the processor based on the braking input, a first braking command specifying a first position of the first control valve, responsive to the first braking command, cause the first shutoff valve to open, responsive to the first braking command, cause the first control valve to move to the first position, obtain, via the one or more input/output interfaces, a current pressure value from the pressure transducer in the line connecting the intelligent brake control valve and the first hydraulically actuated brake, obtain, from a wheelspeed sensor, a current wheelspeed of a wheel connected to the first hydraulically actuated brake, and determine, by the processor, a second braking command, wherein the second braking command is determined based on the current wheelspeed of the wheel and the current pressure value from the pressure transducer.

In one or more of the above examples, the memory further contains instructions which, when executed by the processor, further cause the brake control valve to provide brake system health status information to the distributed network computer, wherein the brake system health status information comprises at least one of the current pressure value from the pressure transducer, the current wheelspeed from the wheel, or an output from a hardware safety monitor.

In one or more of the above examples, the memory further contains instructions, which when executed by the processor, cause the intelligent brake control valve to obtain, via the one or more input/output interfaces, from a second intelligent brake control valve, a second current pressure from a second pressure transducer in a second line connecting the second intelligent brake control valve and a second hydraulically actuated brake, obtain, via the one or more input/output interfaces, from the second intelligent brake control valve, a second current wheelspeed of a second wheel connected to the second hydraulically actuated brake, and determine, by the processor, the second braking command based at least in part on the second current pressure and the second current wheelspeed.

In one or more of the above examples, the memory further contains instructions which, when executed by the processor, cause the intelligent brake control valve to send, via the one or more input/output interfaces, the current pressure value and the current wheelspeed to one or more input/output interfaces of a second intelligent brake control valve.

In one or more of the above examples, the memory further contains instructions which, when executed by the processor, cause the intelligent brake control valve to determine, based on the current wheelspeed of the wheel and the current pressure value from the pressure transducer, whether the wheel is in, or is approaching a lock-up condition. The second braking command is determined based at least in part on whether the wheel is in, or is approaching the lock-up condition. Further, the second braking command causes the first control valve to reduce the pressure in the line connecting the intelligent brake control valve to the first hydraulically actuated brake.

In one or more of the above examples, the braking input is at least one of: received by the distributed network computer from a user control of the aircraft or generated internally by the distributed network computer.

In one or more of the above examples, the intelligent brake control valve is a two-channel intelligent brake control valve, and further comprising a second control valve, wherein the second control valve modulates a hydraulic fluid pressure along a second line connecting the intelligent brake control valve and a second hydraulically actuated brake of the aircraft, a second shutoff valve, wherein the second shutoff valve modulates a supply of pressurized hydraulic fluid to the second control valve, and a second pressure transducer. The memory further contains instructions which, when executed by the processor, cause the intelligent brake control valve to determine, by the processor, a third braking command, responsive to the third braking command, cause the second shutoff valve to open, responsive to the third braking command, cause the second control valve to move to a third position, obtain, via the one or more input/output interfaces, a second current pressure value from the second pressure transducer in the line connecting the intelligent brake control valve and the second hydraulically actuated brake, obtain, from a second wheelspeed sensor, a current wheelspeed of a second wheel connected to the second hydraulically actuated brake, and determine, by the processor, a fourth braking command, wherein the fourth braking command is determined based on the current wheelspeed of the second wheel and the second current pressure value from the second pressure transducer. The fourth braking command causes the second control valve to move to a fourth position.

In another example embodiment a method of brake control comprises obtaining at an intelligent brake control valve, from a distributed network computer of an aircraft, a braking input. The intelligent brake control valve comprises a housing, a first shutoff valve, wherein the first shutoff valve modulates a supply of a pressurized hydraulic fluid to and from the intelligent brake control valve, a first control valve, wherein the first control valve modulates a hydraulic fluid pressure along a line connecting the intelligent brake control valve and a first hydraulically actuated brake of the aircraft, a pressure transducer, and one or more input/output interfaces. The method of brake control further comprises determining, based on the braking input, a first braking command, wherein the first braking command specifies a first position of the first control valve, responsive to the first braking command, causing the first shutoff valve to open, responsive to the first braking command, causing the first control valve to move to the first position, obtaining, via the one or more input/output interfaces, a current pressure value from the pressure transducer in the line connecting the intelligent brake control valve and the first hydraulically actuated brake, obtaining, from a wheelspeed sensor, a current wheelspeed of a wheel connected to the first hydraulically actuated brake, and determining, a second braking command, wherein the second braking command is determined based on the current wheelspeed of the wheel and the current pressure value from the pressure transducer.

In one or more of the above examples, the method of brake control further comprises providing brake system health status information to the distributed network computer, wherein the brake system health status information comprises at least one of the current pressure value from the pressure transducer, the current wheelspeed from the wheel, or an output from a hardware safety monitor.

In one or more of the above examples, the method of brake control further comprises obtaining, via the one or more input/output interfaces, from a second intelligent brake control valve, a second current pressure from a second pressure transducer in a second line connecting the second intelligent brake control valve and a second hydraulically actuated brake, obtaining, via the one or more input/output interfaces, from the second intelligent brake control valve, a second current wheelspeed of a second wheel connected to the second hydraulically actuated brake, and determining the second braking command based at least in part on the second current pressure and the second current wheelspeed.

In one or more of the above examples, the method of brake control further comprises sending, via the one or more input/output interfaces, the current pressure value and the current wheelspeed to one or more input/output interfaces of a second intelligent brake control valve.

In one or more of the above examples, the method of brake control further comprises determining, based on the current wheelspeed of the wheel and the current pressure value from the pressure transducer, whether the wheel is in, or is approaching a lock-up condition, wherein, the second braking command is determined based at least in part on whether the wheel is in, or is approaching the lock-up condition, and wherein the second braking command causes the first control valve to reduce the pressure in the line connecting the intelligent brake control valve to the first hydraulically actuated brake.

In one or more of the above examples, the braking input is at least one of: received by the distributed network computer from a user control of the aircraft or generated internally by the distributed network computer.

In one or more of the above examples, the intelligent brake control valve is a two-channel intelligent brake control valve which includes a second control valve, wherein the second control valve modulates a hydraulic fluid pressure along a second line connecting the intelligent brake control valve and a second hydraulically actuated brake of the aircraft, a second shutoff valve, wherein the second shutoff valve modulates a supply of pressurized hydraulic fluid to the second control valve, and a second pressure transducer. The method of brake control further comprises determining a third braking command, responsive to the third braking command, causing the second shutoff valve to open, responsive to the third braking command, causing the second control valve to move to a third position, obtaining, via the one or more input/output interfaces, a second current pressure value from the second pressure transducer in the line connecting the intelligent brake control valve and the second hydraulically actuated brake, obtaining, from a second wheelspeed sensor, a current wheelspeed of a second wheel connected to the second hydraulically actuated brake, and determining a fourth braking command, wherein the fourth braking command is determined based on the current wheelspeed of the second wheel and the second current pressure value from the second pressure transducer. The fourth braking command causes the second control valve to move to a fourth position.

In yet another example embodiment, a non-transitory machine-readable medium comprising instructions which, when executed by a processor, cause an intelligent brake control valve comprising a housing, a first shutoff valve, wherein the first shutoff valve modulates a supply of a pressurized hydraulic fluid to and from the intelligent brake control valve, a first control valve, wherein the first control valve modulates a hydraulic fluid pressure along a line connecting the intelligent brake control valve and a first hydraulically actuated brake of an aircraft, a pressure transducer, and one or more input/output interfaces, to: obtain, from a distributed network computer of the aircraft, a braking input, determine, based on the braking input a first braking command, wherein the first braking command specifies a first position of the first control valve, responsive to the first braking command, cause the first shutoff valve to open, responsive to the first braking command, cause the first control valve to move to the first position, obtain, via the one or more input/output interfaces, a current pressure value from the pressure transducer in the line connecting the intelligent brake control valve and the first hydraulically actuated brake, obtain, from a wheelspeed sensor, a current wheelspeed of a wheel connected to the first hydraulically actuated brake, and determine, a second braking command, wherein the second braking command is determined based on the current wheelspeed of the wheel and the current pressure value from the pressure transducer.

In one or more of the above examples, the non-transitory machine-readable medium further comprises instructions which, when executed by the processor, cause the intelligent brake control valve to provide brake system health status information to the distributed network computer, wherein the brake system health status information comprises at least one of the current pressure value from the pressure transducer, the current wheelspeed from the wheel, or an output from a hardware safety monitor.

In one or more of the above examples, the non-transitory machine-readable medium further comprises instructions which, when executed by the processor, cause the intelligent brake control valve to obtain, via the one or more input/output interfaces, from a second intelligent brake control valve, a second current pressure from a second pressure transducer in a second line connecting the second intelligent brake control valve and a second hydraulically actuated brake, obtain, via the one or more input/output interfaces, from the second intelligent brake control valve, a second current wheelspeed of a second wheel connected to the second hydraulically actuated brake, and determine the second braking command based at least in part on the second current pressure and the second current wheelspeed.

In one or more of the above examples, the non-transitory machine-readable medium further comprises instructions which, when executed by the processor, cause the intelligent brake control valve to send, via the one or more input/output interfaces, the current pressure value and the current wheelspeed to one or more input/output interfaces of a second intelligent brake control valve.

In one or more of the above examples, the non-transitory machine-readable medium further comprises instructions which, when executed by the processor, cause the intelligent brake control valve to determine, based on the current wheelspeed of the wheel and the current pressure value from the pressure transducer that the wheel is in, or is approaching a lock-up condition. The second braking command is determined based at least in part on the lock-up condition. Further, the second braking command causes the first control valve to reduce the pressure in the line connecting the intelligent brake control valve to the first hydraulically actuated brake.

In one or more of the above examples, the braking input is at least one of: received by the distributed network computer from a user control of the aircraft or generated internally by the distributed network computer.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An intelligent brake control valve comprising:
a housing;
a first shutoff valve, wherein the first shutoff valve modulates a supply of a pressurized hydraulic fluid to and from the intelligent brake control valve;
a first control valve, wherein the first control valve modulates a hydraulic fluid pressure along a line connecting the intelligent brake control valve and a first hydraulically actuated brake of an aircraft;
a pressure transducer;
one or more input/output interfaces;
a processor; and
a memory containing instructions which, when executed by the processor, cause the intelligent brake control valve to:
obtain, from a distributed network computer of the aircraft, a braking input;
determine, by the processor based on the braking input, a first braking command specifying a first position of the first control valve;
responsive to the first braking command, cause the first shutoff valve to open;
responsive to the first braking command, cause the first control valve to move to the first position;
obtain, via the one or more input/output interfaces, a current pressure value from the pressure transducer in the line connecting the intelligent brake control valve and the first hydraulically actuated brake;
obtain, from a wheelspeed sensor, a current wheelspeed of a wheel connected to the first hydraulically actuated brake; and
determine, by the processor, a second braking command, wherein the second braking command is determined based on the current wheelspeed of the wheel and the current pressure value from the pressure transducer.

2. The intelligent brake control valve of claim 1, wherein the memory further contains instructions which, when executed by the processor, further cause the intelligent brake control valve to provide brake system health status information to the distributed network computer, wherein the brake system health status information comprises at least one of the current pressure value from the pressure transducer, the current wheelspeed from the wheel, or an output from a hardware safety monitor.

3. The intelligent brake control valve of claim 1, wherein the memory further contains instructions, which when executed by the processor, cause the intelligent brake control valve to:
obtain, via the one or more input/output interfaces, from a second intelligent brake control valve, a second current pressure from a second pressure transducer in a second line connecting the second intelligent brake control valve and a second hydraulically actuated brake;
obtain, via the one or more input/output interfaces, from the second intelligent brake control valve, a second current wheelspeed of a second wheel connected to the second hydraulically actuated brake; and
determine, by the processor, the second braking command based at least in part on the second current pressure and the second current wheelspeed.

4. The intelligent brake control valve of claim 1, wherein the memory further contains instructions which, when executed by the processor, cause the intelligent brake control valve to:
send, via the one or more input/output interfaces, the current pressure value and the current wheelspeed to one or more input/output interfaces of a second intelligent brake control valve.

5. The intelligent brake control valve of claim 1, wherein the memory further contains instructions which, when executed by the processor, cause the intelligent brake control valve to:
determine, based on the current wheelspeed of the wheel and the current pressure value from the pressure transducer, whether the wheel is in, or is approaching a lock-up condition,
wherein, the second braking command is determined based at least in part on whether the wheel is in, or is approaching the lock-up condition, and
wherein the second braking command causes the first control valve to reduce the hydraulic fluid pressure in the line connecting the intelligent brake control valve to the first hydraulically actuated brake.

6. The intelligent brake control valve of claim 1, wherein the braking input is at least one of: received by the distributed network computer from a user control of the aircraft or generated internally by the distributed network computer.

7. The intelligent brake control valve of claim 1, wherein the intelligent brake control valve is a two-channel intelligent brake control valve, and further comprising:
a second control valve, wherein the second control valve modulates a hydraulic fluid pressure along a second line connecting the intelligent brake control valve and a second hydraulically actuated brake of the aircraft;
a second shutoff valve, wherein the second shutoff valve modulates a supply of pressurized hydraulic fluid to the second control valve; and
a second pressure transducer,
wherein the memory further contains instructions which, when executed by the processor, cause the intelligent brake control valve to:
determine, by the processor, a third braking command;
responsive to the third braking command, cause the second shutoff valve to open;
responsive to the third braking command, cause the second control valve to move to a third position;
obtain, via the one or more input/output interfaces, a second current pressure value from the second pressure transducer in the line connecting the intelligent brake control valve and the second hydraulically actuated brake;
obtain, from a second wheelspeed sensor, a current wheelspeed of a second wheel connected to the second hydraulically actuated brake; and
determine, by the processor, a fourth braking command, wherein the fourth braking command is determined based on the current wheelspeed of the second wheel and the second current pressure value from the second pressure transducer,
wherein the fourth braking command causes the second control valve to move to a fourth position.

8. A method of brake control, comprising:
obtaining at an intelligent brake control valve, from a distributed network computer of an aircraft, a braking input, wherein the intelligent brake control valve comprises:
a housing;
a first shutoff valve, wherein the first shutoff valve modulates a supply of a pressurized hydraulic fluid to and from the intelligent brake control valve;
a first control valve, wherein the first control valve modulates a hydraulic fluid pressure along a line connecting the intelligent brake control valve and a first hydraulically actuated brake of the aircraft;
a pressure transducer; and
one or more input/output interfaces;
determining, based on the braking input, a first braking command, wherein the first braking command specifies a first position of the first control valve;
responsive to the first braking command, causing the first shutoff valve to open;
responsive to the first braking command, causing the first control valve to move to the first position;
obtaining, via the one or more input/output interfaces, a current pressure value from the pressure transducer in the line connecting the intelligent brake control valve and the first hydraulically actuated brake;
obtaining, from a wheelspeed sensor, a current wheelspeed of a wheel connected to the first hydraulically actuated brake; and
determining, a second braking command, wherein the second braking command is determined based on the current wheelspeed of the wheel and the current pressure value from the pressure transducer.

9. The method of claim 8, further comprising providing brake system health status information to the distributed network computer, wherein the brake system health status information comprises at least one of the current pressure value from the pressure transducer, the current wheelspeed from the wheel, or an output from a hardware safety monitor.

10. The method of claim 8, further comprising:
obtaining, via the one or more input/output interfaces, from a second intelligent brake control valve, a second current pressure from a second pressure transducer in a second line connecting the second intelligent brake control valve and a second hydraulically actuated brake;
obtaining, via the one or more input/output interfaces, from the second intelligent brake control valve, a second current wheelspeed of a second wheel connected to the second hydraulically actuated brake; and
determining the second braking command based at least in part on the second current pressure and the second current wheelspeed.

11. The method of claim 8, further comprising:
sending, via the one or more input/output interfaces, the current pressure value and the current wheelspeed to one or more input/output interfaces of a second intelligent brake control valve.

12. The method of claim 8, further comprising:
determining, based on the current wheelspeed of the wheel and the current pressure value from the pressure transducer, whether the wheel is in, or is approaching a lock-up condition,
wherein, the second braking command is determined based at least in part on whether the wheel is in, or is approaching the lock-up condition, and
wherein the second braking command causes the first control valve to reduce the hydraulic fluid pressure in the line connecting the intelligent brake control valve to the first hydraulically actuated brake.

13. The method of claim 8, wherein the braking input is at least one of: received by the distributed network computer from a user control of the aircraft or generated internally by the distributed network computer.

14. The method of claim 8, wherein:
the intelligent brake control valve is a two-channel intelligent brake control valve which includes: a second control valve, wherein the second control valve modulates a hydraulic fluid pressure along a second line connecting the intelligent brake control valve and a second hydraulically actuated brake of the aircraft; a second shutoff valve, wherein the second shutoff valve modulates a supply of pressurized hydraulic fluid to the second control valve; and a second pressure transducer, and
the method further comprises:
determining a third braking command;
responsive to the third braking command, causing the second shutoff valve to open;
responsive to the third braking command, causing the second control valve to move to a third position;
obtaining, via the one or more input/output interfaces, a second current pressure value from the second pressure transducer in the line connecting the intelligent brake control valve and the second hydraulically actuated brake;
obtaining, from a second wheelspeed sensor, a current wheelspeed of a second wheel connected to the second hydraulically actuated brake; and
determining a fourth braking command, wherein the fourth braking command is determined based on the current wheelspeed of the second wheel and the second current pressure value from the second pressure transducer,
wherein the fourth braking command causes the second control valve to move to a fourth position.

15. A non-transitory machine-readable medium comprising instructions which, when executed by a processor, cause an intelligent brake control valve comprising a housing; a first shutoff valve, wherein the first shutoff valve modulates a supply of a pressurized hydraulic fluid to and from the intelligent brake control valve; a first control valve, wherein the first control valve modulates a hydraulic fluid pressure along a line connecting the intelligent brake control valve and a first hydraulically actuated brake of an aircraft; a pressure transducer; and one or more input/output interfaces, to:
obtain, from a distributed network computer of the aircraft, a braking input;
determine, based on the braking input a first braking command, wherein the first braking command specifies a first position of the first control valve;
responsive to the first braking command, cause the first shutoff valve to open;
responsive to the first braking command, cause the first control valve to move to the first position;
obtain, via the one or more input/output interfaces, a current pressure value from the pressure transducer in the line connecting the intelligent brake control valve and the first hydraulically actuated brake;
obtain, from a wheelspeed sensor, a current wheelspeed of a wheel connected to the first hydraulically actuated brake; and
determine, a second braking command, wherein the second braking command is determined based on the current wheelspeed of the wheel and the current pressure value from the pressure transducer.

16. The non-transitory machine-readable medium of claim 15, further comprising instructions which, when executed by the processor, cause the intelligent brake control valve to provide brake system health status information to the distributed network computer, wherein the brake system health status information comprises at least one of the current pressure value from the pressure transducer, the current wheelspeed from the wheel, or an output from a hardware safety monitor.

17. The non-transitory machine-readable medium of claim 15, further comprising instructions which, when executed by the processor, cause the intelligent brake control valve to:
obtain, via the one or more input/output interfaces, from a second intelligent brake control valve, a second current pressure from a second pressure transducer in a second line connecting the second intelligent brake control valve and a second hydraulically actuated brake;
obtain, via the one or more input/output interfaces, from the second intelligent brake control valve, a second current wheelspeed of a second wheel connected to the second hydraulically actuated brake; and
determine the second braking command based at least in part on the second current pressure and the second current wheelspeed.

18. The non-transitory machine-readable medium of claim 15, further comprising instructions which, when executed by the processor, cause the intelligent brake control valve to:
send, via the one or more input/output interfaces, the current pressure value and the current wheelspeed to one or more input/output interfaces of a second intelligent brake control valve.

19. The non-transitory machine-readable medium of claim 15, further comprising instructions which, when executed by the processor, cause the intelligent brake control valve to:
determine, based on the current wheelspeed of the wheel and the current pressure value from the pressure transducer, whether the wheel is in, or is approaching a lock-up condition,
wherein, the second braking command is determined based at least in part on whether the wheel is in, or is approaching the lock-up condition, and
wherein the second braking command causes the first control valve to reduce the hydraulic fluid pressure in the line connecting the intelligent brake control valve to the first hydraulically actuated brake.

20. The non-transitory machine-readable medium of claim 15, wherein the braking input is at least one of: received by the distributed network computer from a user control of the aircraft or generated internally by the distributed network computer.
